(19) United States
(12) Patent Application Publication
(10) Pub. No.: US 2019/0366790 A1
(43) Pub. Date: Dec. 5, 2019

(54) CONTROLLING VEHICLE PITCH WHILE TOWING A TRAILER

(71) Applicant: GM GLOBAL TECHNOLOGY OPERATIONS LLC, Detroit, MI (US)

(72) Inventors: Brian K. Saylor, South Lyon, MI (US); Robert G. Izak, Dryden, MI (US); Matthew G. Kowal, Brighton, MI (US); David T. De Carteret, Fenton, MI (US)

(21) Appl. No.: 16/000,008

(22) Filed: Jun. 5, 2018

(51) Int. Cl. B60G 17/0165; B60G 17/019

(52) U.S. Cl. CPC B60G 17/0165; B60G 17/01908; B60G 2400/0512; B60G 2600/184; B60G 2800/912; B60G 2400/97; B60G 2800/014

(57) ABSTRACT

Examples of techniques for controlling vehicle pitch while the vehicle is towing a trailer are disclosed. In one example implementation according to aspects of the present disclosure, a computer-implemented method includes detecting, by a processing device, a trailer attached to a vehicle. The method further includes responsive to detecting the trailer attached to the vehicle, detecting, by the processing device, a pitch event. The method further includes when a pitch event is detected, determining, by the processing device, whether the pitch event exceeds a pitch threshold. The method further includes, responsive to determining that the pitch event exceeds the pitch threshold, adjusting, by the processing device, a vehicle pitch control device associated with the vehicle to counteract the pitch event for the vehicle and the trailer.

The present disclosure relates to controlling vehicle pitching while towing a trailer.

Modern vehicles (e.g., a car, a sports utility vehicle, a bus, a motorcycle, or any other type of vehicle) can be equipped with pitch control devices to detect and correct pitch of the vehicle. Passive, semi-active, and/or active pitch control devices can be used to counteract the effects of pitch on a vehicle.

Pitch (also referred to as angular displacement) represents movement about a lateral axis of the vehicle and is a measure of how much a vehicle's front and rear ends move with respect to a surface beneath the vehicle. For example, when a vehicle brakes, the front end of the vehicle drops and the rear lifts, causing a forward pitch. Conversely, when a vehicle accelerates, the front end of the vehicle lifts and the read drops, causing a backward pitch. Road roughness can also contribute to pitch.

### SUMMARY

In one exemplary embodiment, a computer-implemented method includes detecting, by a processing device, a trailer attached to a vehicle. The method further includes responsive to detecting the trailer attached to the vehicle, detecting, by the processing device, a pitch event. The method further includes when a pitch event is detected, determining, by the processing device, whether the pitch event exceeds a pitch threshold. The method further includes, responsive to determining that the pitch event exceeds the pitch threshold, adjusting, by the processing device, a vehicle pitch control device associated with the vehicle to counteract the pitch event for the vehicle and the trailer.

In additional examples, the vehicle pitch control device comprises a semi-active damping system. In additional examples, the vehicle pitch control device comprises a semi-active spring system. In additional examples, the method further comprises, responsive to detecting the trailer, determining trailer specifications for the trailer by identifying the trailer and receiving the trailer specifications for the identified trailer from a trailer database. In additional examples, the trailer database stores trailer specifications for a plurality of trailers. In additional examples, the trailer specifications for the trailer are entered into the trailer database by a user. In additional examples, the trailer specifications comprise at least one of a trailer length, a trailer width, and a trailer weight. In additional examples, counteracting the pitch event comprises dampening a pitch motion frequency. In additional examples, the vehicle comprises a sensor, and wherein detecting the pitch event comprises receiving a signal indicative of the pitch event from the sensor.

In another exemplary embodiment a system includes a memory having computer readable instructions and a processing device for executing the computer readable instructions for performing a method. The method includes detecting, by a processing device, a trailer attached to a vehicle. The method further includes responsive to detecting the trailer attached to the vehicle, detecting, by the processing device, a pitch event. The method further includes when a pitch event is detected, determining, by the processing device, whether the pitch event exceeds a pitch threshold. The method further includes, responsive to determining that the pitch event exceeds the pitch threshold, adjusting, by the processing device, a vehicle pitch control device associated with the vehicle to counteract the pitch event for the vehicle and the trailer.

In additional examples, the vehicle pitch control device comprises a semi-active damping system. In additional examples, the vehicle pitch control device comprises a semi-active spring system. In additional examples, the method further comprises, responsive to detecting the trailer, determining trailer specifications for the trailer by identifying the trailer and receiving the trailer specifications for the identified trailer from a trailer database. In additional examples, the trailer database stores trailer specifications for a plurality of trailers. In additional examples, the trailer specifications for the trailer are entered into the trailer database by a user. In additional examples, the trailer specifications comprise at least one of a trailer length, a trailer width, and a trailer weight. In additional examples, counteracting the pitch event comprises dampening a pitch motion frequency.

In yet another exemplary embodiment a computer program product includes a computer readable storage medium having program instructions embodied therewith, wherein the computer readable storage medium is not a transitory signal per se, the program instructions executable by a processing device to cause the processing device to perform a method. The method includes detecting, by a processing device, a trailer attached to a vehicle. The method further includes responsive to detecting the trailer attached to the vehicle, detecting, by the processing device, a pitch event. The method further includes when a pitch event is detected, determining, by the processing device, whether the pitch event exceeds a pitch threshold. The method further includes, responsive to determining that the pitch event exceeds the pitch threshold, adjusting, by the processing device, a vehicle pitch control device associated with the vehicle to counteract the pitch event for the vehicle and the trailer.

In additional examples, the vehicle pitch control device comprises a semi-active damping system. In additional examples, the vehicle pitch control device comprises a semi-active spring system.

The above features and advantages, and other features and advantages, of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1A depicts a vehicle and trailer, the vehicle including a processing system for controlling vehicle pitch while the vehicle is towing the trailer according to aspects of the present disclosure;

FIG. 1B depicts the vehicle and trailer of FIG. 1A experiencing pitch according to one or more embodiments;

FIG. 1C depicts the vehicle and trailer of FIG. 1A experiencing pitch according to one or more embodiments;

FIG. 2 depicts a processing system for controlling vehicle pitch while the vehicle is towing the trailer according to one or more embodiments;

FIG. 3 depicts a flow diagram of a method for controlling vehicle pitch while the vehicle is towing a trailer according to one or more embodiments;

FIG. 4 depicts a flow diagram of a method for controlling vehicle pitch while the vehicle is towing a trailer according to one or more embodiments;

FIG. 5 depicts a graph of various damping effects plotted as damping force compared to vehicle velocity according to one or more embodiments; and

FIG. 6 depicts a block diagram of a processing system for implementing the techniques described herein according to an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The technical solutions described herein provide for controlling vehicle pitch while towing a trailer. Current vehicle pitch control devices only correct vehicle pitch for the vehicle and do not consider the presence of a trailer attached to the vehicle. Towing of a trailer can result in a pitching (or bucking/chucking) due to the pitch moment of inertia being out of tune with the natural ride frequencies of the vehicle when not towing. In fact, pitch moment of inertia is often greater with a trailer than without. The present techniques improve existing pitch control technologies by detecting pitching of a vehicle having a trailer connected thereto and then, using semi-active dampers and/or a semi-active spring system of the vehicle, resisting the pitching to dampen and control the pitch quickly.

The techniques described herein provide improvements over the prior art, and in particular, to vehicle pitch control technologies. For example, the present techniques improve vehicle passenger ride comfort and reduced wear to the vehicle by counteracting damping. In particular, wear of the vehicle's suspension components can be improved by reducing damping. This can be accomplished, for example, by using semi-active dampers and/or semi-active springs in the vehicle to counteract and reduce the damping associated with a vehicle and trailer combination. Therefore, the present techniques represent improvements to vehicle ride quality, vehicle performance, passenger ride quality, and vehicle component wear, among others.

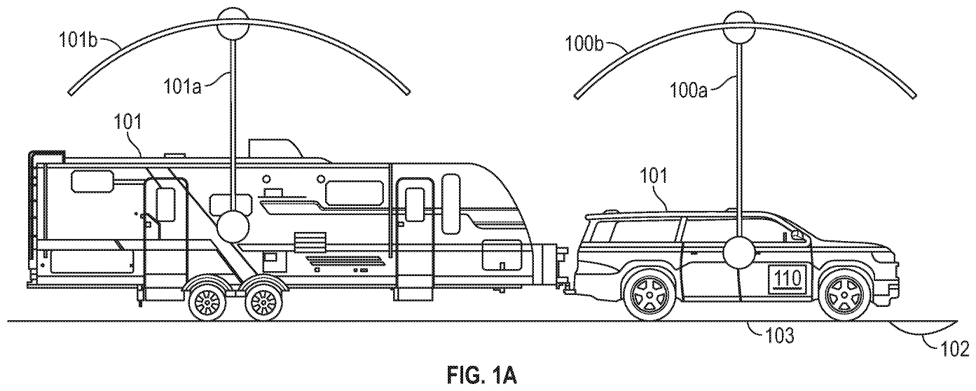

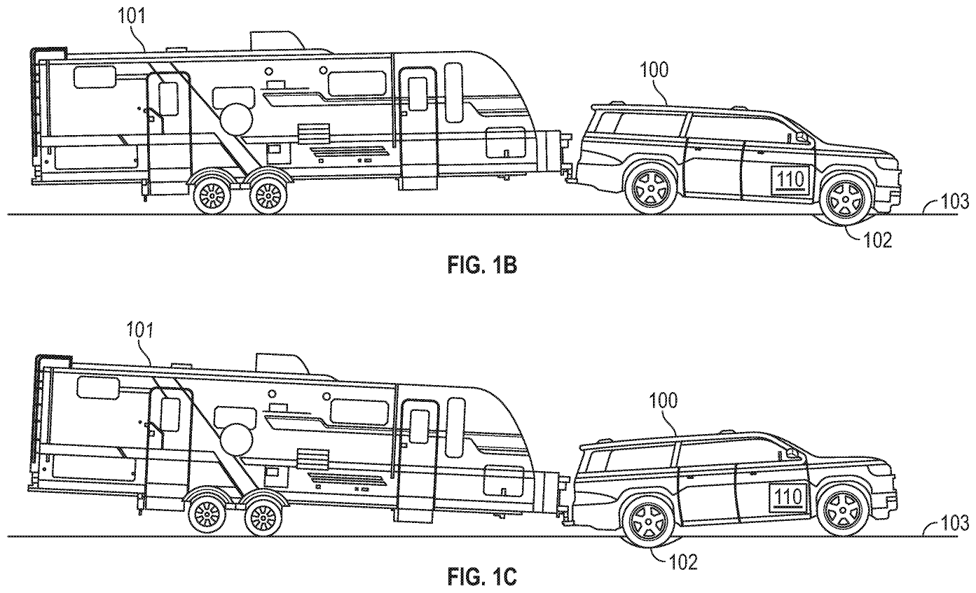

FIG. 1A depicts a vehicle 100 and trailer 101, the vehicle 100 including a processing system 110 for controlling vehicle pitch while the vehicle 100 is towing the trailer 101 according to one or more embodiments. The vehicle 100 is connected to the trailer 101 by a suitable connection, such as a tow hitch, a fifth-wheel coupling, or another suitable connection.

The processing system 110 detects pitch of the vehicle 100 and the trailer 101 and corrects for the pitch. Pitch often occurs when, for example, the vehicle 100 encounters road roughness. The indicators 100a and 101a, for each of the vehicle 100 and the trailer 101 respectively, depict angles of pitch along arcs 100b, 101b respectively. If the vehicle 100 experiences pitch, the trailer 101 is also subjected to pitch resulting from the trailer 101 being connected to the vehicle 100.

As one such example, a pothole 102 can be present in a road surface 103. When a road wheel of the vehicle 100 hits the pothole 102, the vehicle 100 experiences pitch. For example, as depicted in FIG. 1B, when a front road wheel of the vehicle 100 hits the pothole 102, the front of the vehicle 100 pitches down (relative to the road surface 103), causing the rear of the vehicle 100 to pitch up (relative to the road surface 103). In this example, the indicator 100a would tilt towards the right in FIG. 1A. This pitching also affects the trailer, which is shown in FIG. 1B to pitch up in the front and down in the back as a result of the pitching of the vehicle 100. The indicator 101a would tilt towards the left in FIG. 1A.

In another example as depicted in FIG. 1C, when a rear road wheel of the vehicle 100 hits the pothole 102, the rear of the vehicle 100 pitches down (relative to the road surface 103), causing the front of the vehicle 100 to pitch up (relative to the road surface 103). This pitching also affects the trailer, as shown. The indicators 100a, 101a would tilt towards the left and right respectively.

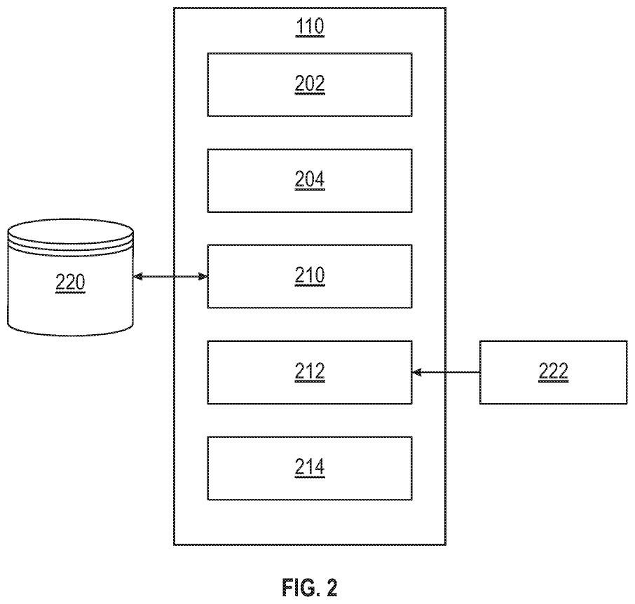

FIG. 2 depicts the processing system 110 for controlling vehicle pitch while the vehicle 100 is towing the trailer 101 according to one or more embodiments. The processing system 110 includes a processing device 202, a memory 204, a trailer detection engine 210, a pitch detection engine 212, and a pitch control engine 214. Together, the engines 210, 212, 214 detect a trailer, detect pitch of the vehicle, and control the pitch.

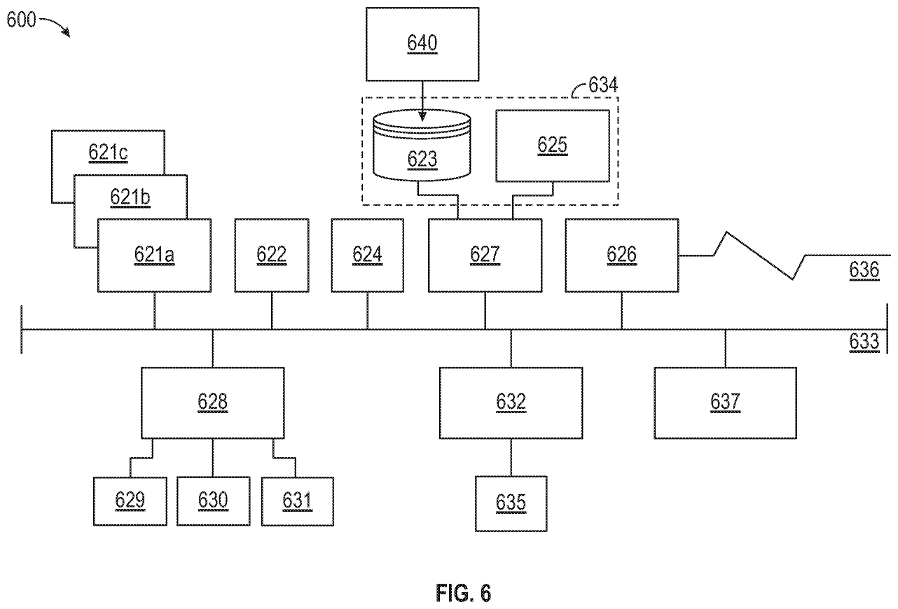

The various components, modules, engines, etc. described regarding FIG. 2 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming The programming can be processor executable instructions stored on a tangible memory, and the hardware can include a processing device (e.g., the CPU 621 of FIG. 6) for executing those instructions. Thus a system memory (e.g., the RAM 624 of FIG. 6) can store program instructions that when executed by the processing device implement the engines described herein. Other engines can also be utilized to include other features and functionality described in other examples herein. It should be appreciated that the processing system 110 can be an inertial measurement unit.

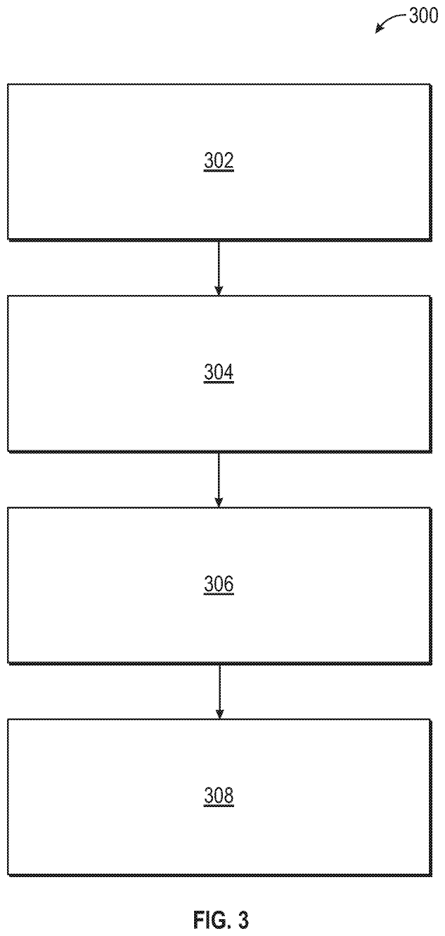

The various components of FIG. 2 are now described in more detail with reference to FIG. 3. In particular, FIG. 3 depicts a flow diagram of a method 300 for controlling vehicle pitch while the vehicle is towing the trailer according to one or more embodiments. The method 300 can be performed by any suitable system or device such as the processing system 110 of FIG. 2, the processing system 600 of FIG. 6, and/or any other suitable processing system and/or processing device (e.g., a processor). It should be appreciated that the method 300 can also be performed by an initial measurement unit within the vehicle.

At block 302, the trailer detection engine 210 detects a trailer (e.g., the trailer 101) attached to a vehicle (e.g., the vehicle 100). The trailer can be detected by an electrical connection between the vehicle and the trailer, for example, or by a user indicating, such as using a user interface within the vehicle, that the trailer is attached to the vehicle. According to one or more embodiments, the trailer detection engine 210 can determine trailer specifications for the trailer. This can be accomplished by identifying the trailer (e.g., automatically by the electrical connection between the trailer and the vehicle, manually by a user specifying the trailer that is attached, etc.). The trailer detection engine 210 can receive trailer specifications from a trailer database 220 of FIG. 2, which can be stored in the vehicle and/or remotely (e.g., in a cloud computing environment). In another example, the trailer specifications for the trailer are entered into the trailer database by the user. The trailer specifications can include various data about the trailer, such as a trailer length, a trailer width, a trailer weight, a number of axles, and a trailer tongue length, among others.

At block 304, the pitch detection engine 212 detects a pitch event of the vehicle after detecting that the trailer is attached to the vehicle. The pitch detection engine 212 can receive signals from a sensor 222, FIG. 2, associated with the vehicle. For example, the sensor 222 can be an array of sensors associated with the front and rear suspension of the vehicle. The sensor 222 can detect a pitch event within specific frequency range and for approximately 180 degrees out of phase of the specific frequency range for a length of time.

At block 306, the pitch detection engine 212 determines whether the detected pitch event exceeds a pitch threshold. The pitch threshold can be determined based on the trailer specifications and/or specification of the vehicle. For example, a long trailer has a big moment of pitch. It may therefore be desirable to have a lower threshold for a longer trailer compared to a shorter trailer (with a higher threshold) in order to detect and control pitch before the pitch becomes too great.

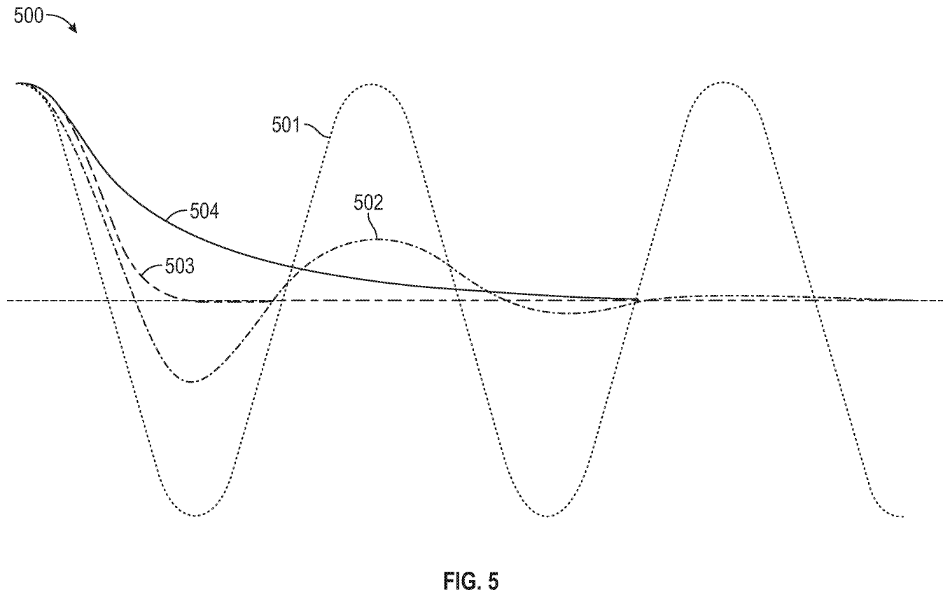

At block 308, when the pitch event exceeds the threshold at block 306, the pitch control engine 214 adjusts a vehicle pitch control device to counteract the pitch event for the vehicle and the trailer. The pitch control device can be a semi-active damping system or a semi-active spring system. The pitch event can be counteracted by the pitch control device as shown in the graph 500 of FIG. 5, which depicts various damping effects plotted as damping force (vertical axis) compared to vehicle velocity (horizontal axis). In particular, line 501 represents an undamped state, line 502 represents an underdamped state, line 503 represents an overdamped state, and line 504 represents a normally damped state.

In some examples, the pitch control engine 214 can implement a phase lock loop technique to adjust the pitch damping frequency so that the vehicle pitch control device matches the damping frequency of the combined vehicle and trailer.

Additional processes also may be included, and it should be understood that the process depicted in FIG. 3 represents an illustration, and that other processes may be added or existing processes may be removed, modified, or rearranged without departing from the scope and spirit of the present disclosure.

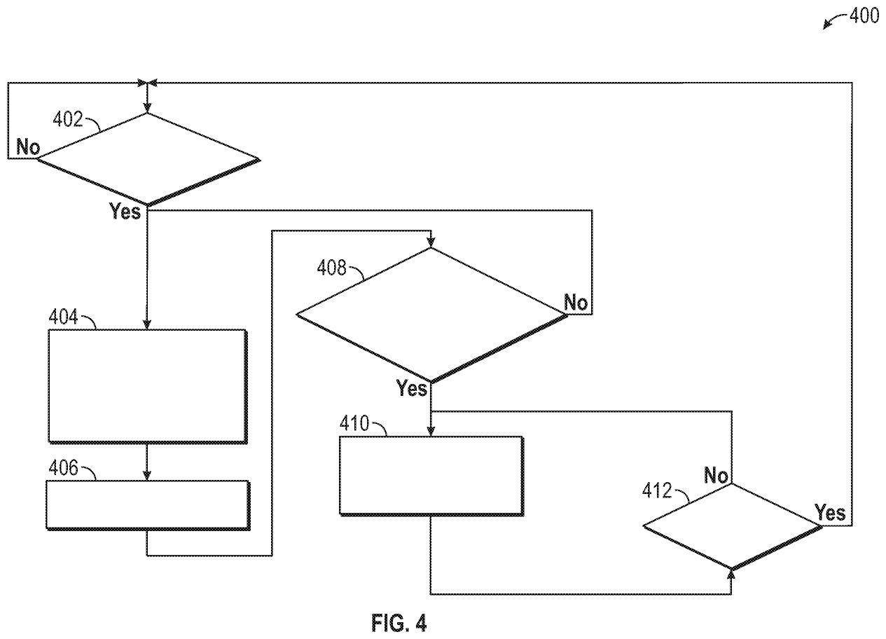

FIG. 4 depicts a flow diagram of a method 400 for dynamic batch size selection according to aspects of the present disclosure. The method 400 can be performed by any suitable system or device such as the processing system 110 of FIG. 2, the processing system 600 of FIG. 6, and/or any other suitable processing system and/or processing device (e.g., a processor).

At decision block 402, it is determined whether a trailer (e.g., the trailer 101) is attached to a vehicle (e.g., the vehicle 100). If not, the method 400 restarts. However, if it is determined at decision block 402 that a trailer is attached to the vehicle, the method 400 proceeds to block 404, and an inertial measurement unit (IMU) or other suitable processing device or system records motion data, such as from sensors associated with the suspension system of the vehicle. The motion data can be collected from front and rear suspension sensors 222 to record motion data within specific frequency range and for approximately 180 degrees out of phase of the specific frequency range for a length of time.

At block 406, resonance pitch filtering is performed on the motion data to filter the resonance pitch frequency out of the motion data. At decision block 408, it is then determined whether the resonance pitch frequency from block 406 indicates pitching of the vehicle and trailer. If not, the method 400 returns to recording motion data at block 404. However, if it is determined at decision block 408 that pitching is indicated, damping is initiated at block 410 to counteract the pitch event for the vehicle and the trailer. This can include performing a phase lock loop technique and/or adjusting semi-active dampers and/or semi-active springs in the vehicle to counteract the damping. At decision block 412, it is determined whether the vehicle experiences a key cycle (i.e., turning the ignition key off and back on). If no key cycle occurs, the method 400 continues to implement the damping, as may be appropriate. However, if a key cycle occurs at the decision block 412, the method 400 ends and/or restarts at decision block 402.

Additional processes also may be included, and it should be understood that the process depicted in FIG. 4 represents an illustration and that other processes may be added or existing processes may be removed, modified, or rearranged without departing from the scope and spirit of the present disclosure.

It is understood that the present disclosure is capable of being implemented in conjunction with any other type of computing environment now known or later developed. For example, FIG. 6 depicts a block diagram of a processing system 600 for implementing the techniques described herein. In examples, processing system 600 has one or more central processing units (processors) 621a, 621b, 621c, etc. (collectively or generically referred to as processor(s) 621 and/or as processing device(s)). In aspects of the present disclosure, each processor 621 can include a reduced instruction set computer (RISC) microprocessor. Processors 621 are coupled to system memory (e.g., random access memory (RAM) 624) and various other components via a system bus 633. Read only memory (ROM) 622 is coupled to system bus 633 and may include a basic input/output system (BIOS), which controls certain basic functions of processing system 600.

Further depicted are an input/output (I/O) adapter 627 and a network adapter 626 coupled to system bus 633. I/O adapter 627 may be a small computer system interface (SCSI) adapter that communicates with a hard disk 623 and/or a storage drive 625 or any other similar component. I/O adapter 627, hard disk 623, and storage device 625 are collectively referred to herein as mass storage 634. Operating system 640 for execution on processing system 600 may be stored in mass storage 634. A network adapter 626 interconnects system bus 633 with an outside network 636 enabling processing system 600 to communicate with other such systems.

A display (e.g., a display monitor) 635 is connected to system bus 633 by display adaptor 632, which may include a graphics adapter to improve the performance of graphics intensive applications and a video controller. In one aspect of the present disclosure, adapters 626, 627, and/or 632 may be connected to one or more I/O busses that are connected to system bus 633 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 633 via user interface adapter 628 and display adapter 632. A keyboard 629, mouse 630, and speaker 631 may be interconnected to system bus 633 via user interface adapter 628, which may include, for example, a Super I/O chip integrating multiple device adapters into a single integrated circuit.

In some aspects of the present disclosure, processing system 600 includes a graphics processing unit 637. Graphics processing unit 637 is a specialized electronic circuit designed to manipulate and alter memory to accelerate the creation of images in a frame buffer intended for output to a display. In general, graphics processing unit 637 is very efficient at manipulating computer graphics and image processing, and has a highly parallel structure that makes it more effective than general-purpose CPUs for algorithms where processing of large blocks of data is done in parallel.

Thus, as configured herein, processing system 600 includes processing capability in the form of processors 621, storage capability including system memory (e.g., RAM 624), and mass storage 634, input means such as keyboard 629 and mouse 630, and output capability including speaker 631 and display 635. In some aspects of the present disclosure, a portion of system memory (e.g., RAM 624) and mass storage 634 collectively store an operating system to coordinate the functions of the various components shown in processing system 600.

The descriptions of the various examples of the present disclosure have been presented for purposes of illustration, but are not intended to be exhaustive or limited to the embodiments disclosed. Many modifications and variations will be apparent to those of ordinary skill in the art without departing from the scope and spirit of the described techniques. The terminology used herein was chosen to best explain the principles of the present techniques, the practical application or technical improvement over technologies found in the marketplace, or to enable others of ordinary skill in the art to understand the techniques disclosed herein.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present techniques not be limited to the particular embodiments disclosed, but will include all embodiments falling within the scope of the application.

What is claimed is:

1. A computer-implemented method comprising:
detecting, by a processing device, a trailer attached to a vehicle;
responsive to detecting the trailer attached to the vehicle, detecting, by the processing device, a pitch event;
when a pitch event is detected, determining, by the processing device, whether the pitch event exceeds a pitch threshold; and
responsive to determining that the pitch event exceeds the pitch threshold, adjusting, by the processing device, a vehicle pitch control device associated with the vehicle to counteract the pitch event for the vehicle and the trailer.

2. The computer-implemented method of claim 1, wherein the vehicle pitch control device comprises a semi-active damping system.

3. The computer-implemented method of claim 1, wherein the vehicle pitch control device comprises a semi-active spring system.

4. The computer-implemented method of claim 1, further comprising:
responsive to detecting the trailer, determining trailer specifications for the trailer by identifying the trailer and receiving the trailer specifications for the identified trailer from a trailer database.

5. The computer-implemented method of claim 4, wherein the trailer database stores trailer specifications for a plurality of trailers.

6. The computer-implemented method of claim 4, wherein the trailer specifications for the trailer are entered into the trailer database by a user.

7. The computer-implemented method of claim 4, wherein the trailer specifications comprise at least one of a trailer length, a trailer width, and a trailer weight.

8. The computer-implemented method of claim 1, wherein counteracting the pitch event comprises dampening a pitch motion frequency.

9. The computer-implemented method of claim 1, wherein the vehicle comprises a sensor, and wherein detecting the pitch event comprises receiving a signal indicative of the pitch event from the sensor.

10. A system comprising:
a memory comprising computer readable instructions; and
a processing device for executing the computer readable instructions for performing a method comprising:
detecting, by the processing device, a trailer attached to a vehicle;
responsive to detecting the trailer attached to the vehicle, detecting, by the processing device, a pitch event;
when a pitch event is detected, determining, by the processing device, whether the pitch event exceeds a pitch threshold; and
responsive to determining that the pitch event exceeds the pitch threshold, adjusting, by the processing device, a vehicle pitch control device associated with the vehicle to counteract the pitch event for the vehicle and the trailer.

11. The system of claim 10, wherein the vehicle pitch control device comprises a semi-active damping system.

12. The system of claim 10, wherein the vehicle pitch control device comprises a semi-active spring system.

13. The system of claim 10, wherein the method further comprises:
responsive to detecting the trailer, determining trailer specifications for the trailer by identifying the trailer and receiving the trailer specifications for the identified trailer from a trailer database.

14. The system of claim 13, wherein the trailer database stores trailer specifications for a plurality of trailers.

15. The system of claim 13, wherein the trailer specifications for the trailer are entered into the trailer database by a user.

16. The system of claim 13, wherein the trailer specifications comprise at least one of a trailer length, a trailer width, and a trailer weight.

17. The system of claim 10, wherein counteracting the pitch event comprises dampening a pitch motion frequency.

18. A computer program product comprising:
a computer readable storage medium having program instructions embodied therewith, the program instructions executable by a processing device to cause the processing device to perform a method comprising:
detecting, by the processing device, a trailer attached to a vehicle;
responsive to detecting the trailer attached to the vehicle, detecting, by the processing device, a pitch event;
when a pitch event is detected, determining, by the processing device, whether the pitch event exceeds a pitch threshold; and
responsive to determining that the pitch event exceeds the pitch threshold, adjusting, by the processing device, a vehicle pitch control device associated with the vehicle to counteract the pitch event for the vehicle and the trailer.

19. The computer program product of claim 18, wherein the vehicle pitch control device comprises a semi-active damping system.

20. The computer program product of claim 18, wherein the vehicle pitch control device comprises a semi-active spring system.
